(19) United States
(12) Patent Application Publication
(10) Pub. No.: US 2008/0076381 A1
(43) Pub. Date: Mar. 27, 2008

(54) Method and System for Connecting People in an Internet-Type Telecommunication Network

(75) Inventors: Arnaud Vilain, Paris (FR); Jean-Paul Rodrigues, Clamart (FR)

Correspondence Address: COHEN, PONTANI, LIEBERMAN & PAVANE, 551 FIFTH AVENUE, SUITE 1210, NEW YORK, NY, 10176, US

(73) Assignee: FRANCE TELECOM, Paris (FR)

(21) Appl. No.: 11/793,472

(22) PCT Filed: Dec. 19, 2005
(86) PCT No.: PCT/FR05/51103

§ 371 Date: Nov. 2, 2007

(30) Foreign Application Priority Data
Dec. 20, 2004 (FR) 0413557

(51) Int. Cl. H04Q 7/20; H04N 7/14

(52) U.S. Cl. 455/403; 348/14.02

(57) ABSTRACT

A method of connecting people (A, B, C, D) in a telecommunications network includes a step (E10) of creating two or more groups (G1, G2) of people as a function of their profiles. It sets up (E20) successive interviews (E_{AB}, E_{AC}, E_{AD}) between all possible combinations of the people belonging to the two groups. The setting up (E20) of each interview includes the following steps: selecting (E30) two people (A, B) belonging to the two groups, setting up (E40) one or more audio and video data streams (f1, f2) between those people at a predetermined time (t1), and breaking off (E50) the one or more data streams after a predetermined duration (D1). Use in a videophone dating service.

### BACKGROUND OF THE INVENTION

The present invention proposes a method and a system for making contact via videophone in order to connect people seeking to make contact via conversational terminals connected to a telecommunications network.

The general context of the invention is that of what is known as speed dating.

Speed dating is a known dating method in which people belonging to separate groups seek to make contact during face to face interviews. This dating method is generally organized by establishments (cafes, restaurants, bars, etc.) to attract customers who are single.

Although very fashionable, in particular in large towns, speed dating in its existing form has some limitations.

Firstly, it requires that people meet in a predetermined place.

Secondly, to ensure that all people in one group have the opportunity to talk to all people in another group, it is necessary to ensure that interviews stick to a predetermined duration.

### OBJECT AND SUMMARY OF THE INVENTION

A main object of the present invention is to alleviate such drawbacks.

To this end, a first aspect of the present invention is directed to a method of connecting people in a telecommunications network including a step of creating two or more groups of people as a function of their profiles.

The method sets up successive interviews between all possible combinations of people belonging to two separate groups, setting up each interview including the following steps:

selecting two people belonging to respective separate groups;

setting up one or more audio and video data streams between said people at a predetermined time; and

breaking off the data stream(s) after a predetermined duration.

Thus the present invention connects people via a videophone service using an Internet-type telecommunications network.

In the remainder of this document, the expression Internet-type telecommunications network refers to any network enabling terminals to communicate using the Internet Protocol (IP).

This connection service can be provided to people who use a webcam, a PC, or a UMTS terminal, for example people who subscribe to the service, and to people who use a terminal dedicated to this service, namely a videophone.

The connection method of the invention advantageously ensures that people from the two groups have the opportunity to make contact, two by two, within a predetermined period, so that all interviews can be conducted over a reasonable time period.

Correspondingly, the invention is directed to a system for connecting people in an Internet-type telecommunications network, the system including means for creating two or more groups of people as a function of their profiles. The system includes means for setting up successive interviews between all possible combinations of people belonging to two separate groups, these means including:

means for selecting two people belonging to respective separate groups;

means for setting up one or more audio and video data streams between those people; and

means for breaking off the data stream after a predetermined duration.

The method of the invention preferably includes, after the step of breaking off a interview between two people, a step of storing an assessment of the interview by one of the two people in a data structure accessible to both people.

A preferred embodiment of the system of the invention includes a data structure accessible by both people who have participated in a interview for storing an assessment of that interview by a first of the two people.

Storing this assessment provides a more interactive service whereby a participant can consult the feelings of people previously contacted.

To this end, following a interview, the method can allow each of the participants one minute, for example, to note their impressions of the interview.

If the network is the Internet, the data structure for storing these assessments can be a web page.

Under such circumstances, subscribers and users who access the service via a PC, a webcam or a UMTS terminal can record their assessments on the web page directly.

Otherwise, the method offers subscribers who use a dedicated videophone, after the step of breaking off the interview:

a step of creating a session set up between that person and a portal of said network; and

during that session, a step of the person sending the assessment to the portal;

the step of storing the assessment being effected by the portal.

This video portal combines video server and web server technologies. When a participant calls a declared number on the video server, a script in the web server in a language suited to video is invoked via an http request and the participant's assessment is stored.

Because a web server is used, it is possible to generate pages with dynamic contents using scripts written in the hypertext preprocessor (PHP) language, for example.

The PHP language being known to the person skilled in the art, it is not described here. It is a generalist open source script language specifically designed for developing web applications. It can easily be integrated into HTML. For more information, the person skilled in the art may refer to http://fr2.php.net/manual/frindex.php.

Of course, other technologies such as servlets or JSP (Java Server Pages) can be envisaged.

Video portal technology has the advantage of procuring other benefits in that it offers both a web interface and a video interface, which significantly reduces the cost of developing such a service.

In practice, a session between the participant in the interview and the video portal is set up by means of a videoconference protocol. A home page is sent to the participant.

The H323 videoconference protocol, the Session Initiation Protocol (SIP), or any protocol for setting up an audio/video call between two terminals via an Internet-type telecommunications network can be used.

In these embodiments, the assessment is preferably sent to the portal 40 in the form of a DTMF command.

For example, the DTMF command is sent “out of band” on the H245 signaling channel set up with the video portal.

VXML pages are hosted on the web server or generated dynamically by the web server, reception of a DTMF command chaining the screens sent to the participants and rendering their contents dynamic.

To set up subsequent interviews, one or more assessments of a preceding interview are optionally used during the aforementioned selection step.

For example, this means that interviews can be organized in accordance with criteria that are refined by the participants, but also that preferential treatment can be given to interviews liable to connect people having more chance of liking each other, for example by assigning them a longer predetermined duration.

The advantages and the particular features of the system according to the invention being identical to those of the method referred to above, they are not repeated here.

A preferred architecture of the system of the invention includes:

a session server adapted:

to create the groups; and

to select the people for a interview, where applicable using an assessment (of a preceding interview); and

a call distributor adapted:

to obtain a predetermined time and a predetermined duration for a interview on reception of a message from the session server; and

to select a call launcher from a plurality of call launchers for setting up one or more audio and video data streams between the people;

the call launcher being placed at a break-in point of the stream and adapted:

to break off the stream after the predetermined duration; and

to send a message to the session server after the break.

The invention therefore also provides a session server adapted to be used in an Internet-type telecommunications network, which session server includes:

means for creating two or more separate groups of people as a function of their profile; and

means for initiating contact by videophone between all possible combinations of two people belonging to respective groups.

The session server preferably implements the web server that hosts the web page storing assessments of completed interviews.

This session server preferably updates a data structure for scheduling all interviews (participants, interview time and duration) and profiles of participants.

A plurality of call launchers (or videoconference bridges) handle the load represented by this videophone dating service.

A call launcher sets up a call between two terminals in a manner that is transparent. Being placed at a break-in position between the terminals, it is able to manage the duration of the call.

Thus the invention also relates to a call launcher that can be used in an Internet-type telecommunications network and includes:

means for setting up on reception of a message one or more audio and video streams between two terminals of the network at a predetermined time; and

means for breaking off that stream after a predetermined duration.

To distribute the load between the various call launchers, the call distributor preferably uses a round-robin type calculation to select the call launcher that is the least heavily loaded as a function of the time and duration of the interview obtained from the session server.

As is known in the art, in a round-robin type calculation, each process has a quantum of time for which it can run before handing over to the next process.

The call launcher includes a clock (timer) and breaks off the audio-video stream between the participants when the predetermined interview duration has elapsed.

In a preferred embodiment, the session server and the call launcher consist of standard computers executing computer programs.

Consequently, the invention is also directed to a computer program stored on an information medium. The program can be executed by a call launcher. It includes means for executing:

a step of establishing on reception of a message one or more audio and video streams between two terminals of said network at a predetermined time; and

a step of breaking off said stream after a predetermined duration.

The invention is also directed to a computer program stored on an information medium that can be executed by a session server and includes instructions for executing:

a step of creating two or more separate groups of people as a function of their profile; and

a step of initiating contact by videophone between all possible combinations of two people belonging to the respective groups.

Each of the above programs can use any programming language and be in the form of source code, object code, or an intermediate code between source code and object code, such as in a partially compiled form, or in any other desirable form.

The invention is also directed to an information medium containing instructions of a computer program as referred to above.

This information medium may be any entity or device capable of storing the program. For example, it may include storage means, such as a ROM, for example a CD-ROM or a micro-electronic circuit ROM, or magnetic storage means, for example a diskette (floppy disk) or a hard disk.

Moreover, this information medium can be a transmissible medium such as an electrical or optical signal, which can be routed via an electrical or optical cable, by radio or by other means. The programs of the invention may in particular be downloaded over an Internet-type network.

Alternatively, the information medium could be an integrated circuit incorporating the program and adapted to execute the method in question or to be used in its execution.

### BRIEF DESCRIPTION OF THE DRAWINGS

Other features and advantages of the present invention emerge from the description given below with reference to the appended drawings, which show one non-limiting embodiment of the invention. In the figures:

FIG. 1 represents, in flowchart form, the main steps of a preferred embodiment of a method of the invention for connecting people; and

FIG. 2 represents a preferred embodiment of a system of the invention for connecting people.

### DETAILED DESCRIPTION OF ONE EMBODIMENT

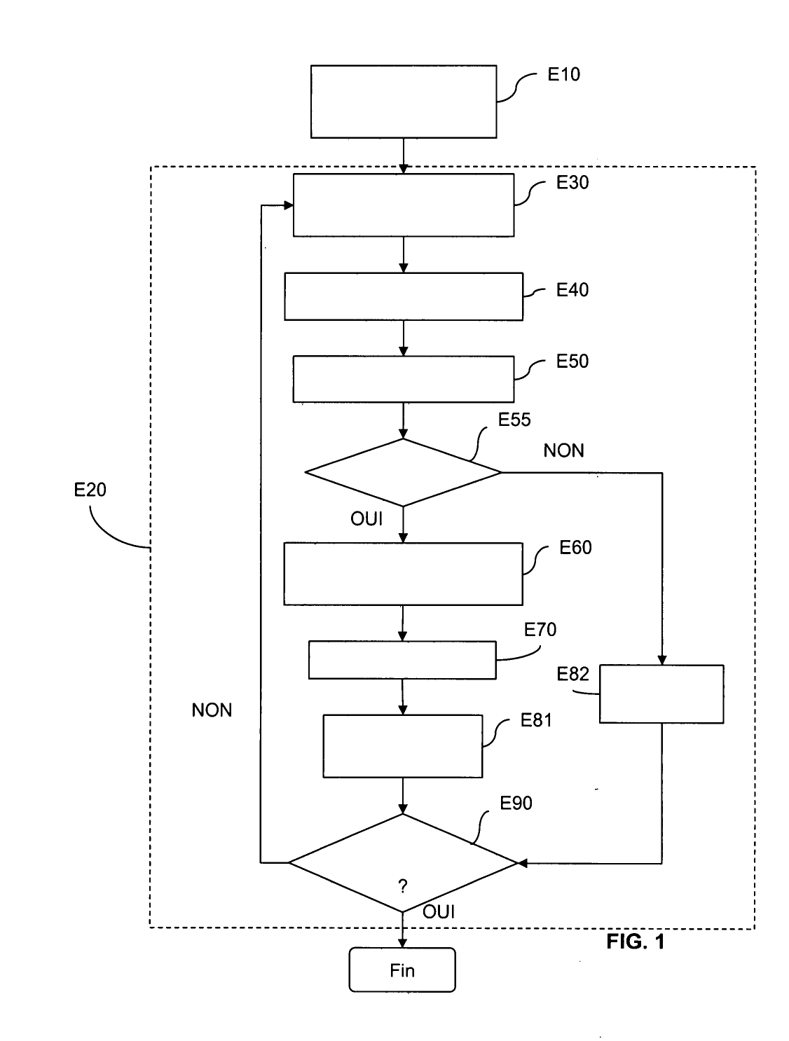

FIG. 1 represents a preferred embodiment of a method of the invention for connecting people.

This method includes a first step E10 during which separate groups of people are created as a function of their profiles.

A subscriber's profile is typically provided by the subscriber, either at the time of subscribing to the videophone dating service or subsequently, by completing a form by means of a terminal that is used to access the service (videophone, personal computer, UMTS telephone).

For example, the profile includes the characteristics of the person (age, sex, height, color of eyes, etc.) or information on their tastes (sports, culture, reading, etc.).

The profile for each person also gives the characteristics or tastes of people they would like to contact via the videophone dating service.

For example, a profile might contain the information that a person would prefer to contact a non-smoker.

The step E10 of creating groups consists primarily in combining into groups people having similar characteristics, tastes or requirements.

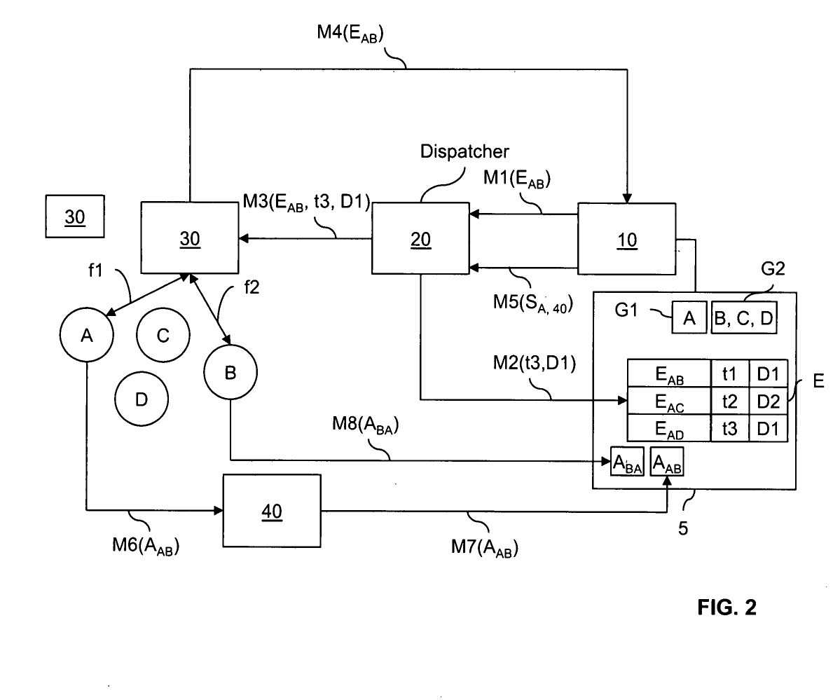

In the example described here with reference to FIG. 2, this step E10 leads to the creation of:

a first group G1 including one person A; and

a second group G2 including three people B, C, and D.

As represented by a general step E20, the method of the invention is generally used to set up successive interviews between all possible combinations of people belonging to two different groups.

Accordingly, in the example described here, the invention is used to set up the following interviews:

interview E_{AB} between people A and B;

interview E_{AC} between people A and C; and

interview E_{AD} between people A and D.

This general step E20 is described in detail next.

Firstly, two people belonging to the different groups G1 and G2 are selected (step E30).

This selection can be based on various criteria, for example alphabetical order or the order in which people first subscribe to the videophone dating service.

In the example described here, it is assumed that this selection step is based on alphabetical order.

Consequently, this selection step selects the people A and B from the groups G1 and G2.

This selection step E30 is followed by a step E40 of setting up one or more audio and video data streams between the people selected in the preceding step E30.

When this data stream has been set up, the interview can commence.

According to the invention, this interview is set up for a particular duration, typically less than ten minutes.

Consequently, the connection method of the invention includes a step E50 of breaking off the aforementioned data stream when the predetermined duration expires.

In a preferred embodiment, the method of the invention also provides for storing an assessment made by a person following a interview.

To this end, if the terminal of a user is a videophone (the result of the test E55 is then positive), a session is set up between that videophone and a video portal 40.

As already described, this video portal combines the video server and web server functions and the session with the person is set up by means of the videoconference protocol.

During the session, the video portal sends the videophone terminal of the person a home page on which they can given an assessment on the interview with the other participant that has just finished.

In this document, A_{AB} denotes an assessment by the person A of the interview E_{AB} and A_{BA} denotes an assessment by the person B of the same interview E_{AB}.

This assessment can preferably be chosen from a set proposed on the home page by pressing a key of the videophone.

A DTMF command is then sent to the portal 40 on the signaling channel H245 (step E70).

Be this as it may, in a step E81 the assessment A_{AB} is stored by the portal 40 in a data structure 5 accessible to both participants A and B.

The data structure 5 is accessible via a web page if the subscriber is on the Internet or on a VXML page serviced by the video server if the subscriber is using a dedicated terminal.

Otherwise, if the participant is using a terminal other than a videophone, for example a personal computer, a webcam or a UMTS telephone (the result of the test 55 is then negative), the user stores an assessment directly on the web page in a step E82.

This web page can of course be accessed subsequently by subscribers to the videophone dating service to consult the assessments given by people they have contacted.

Be this as it may, the storage steps E81 and E82 are followed by a test E90 which verifies if other interviews can be effected between people from groups G1 and G2.

In the example described here, two other interviews can be effected, either between the person A and the person C (interview E_{AC}) or between the person A and the person D (interview E_{AD}).

If other interviews must be effected, the result of the test E90 is negative.

This test is then followed by the step E30, already described, during which two people are selected to set up the next interview.

This selection step E30 preferably uses one or more assessments from a previous interview.

Thus, if during the interview E_{AB} the person A gave an assessment according to which they would prefer to contact a non-smoker, and if the people C and D are a smoker and a non-smoker, respectively, the step E30 can prioritize selecting the interview E_{AD} between the people A and D.

Be this as it may, the selection step E30 is followed by the step E40 of setting up a data stream between the people selected as described above.

When all possible interviews between the people from the two groups have taken place, the result of the test E90 is positive and in this embodiment the connection process terminates.

A system for implementing the method described above is described next with reference to FIG. 2.

This system is implemented in a telecommunications network offering voice over IP (Internet Protocol) services, for example a VoIP (Voice over IP) network.

In the embodiment described here, the system includes a session server (web server) 10 to which a person subscribing to the dating service can connect by means of a UMTS cellular telephone or any electronic data processing unit provided with a connection interface (PC, webcam, etc.).

The website in particular enables a subscriber to fill out the form defining that subscriber's profile and to sign up for a session for connecting people.

Signing up for a session is preferably confirmed by sending an electronic mail or a message (for example an SMS message).

For subscribers having only a dedicated terminal, with no Internet connection, filling out the profile form and signing up for a given session are effected via the video portal 40.

To this end, the portal 40 is adapted to send an HTTP request to the web server 10 to request the sending of a VXML page enabling such subscribers to enter their response via the portal 40.

Be this as it may, the web server 10 includes the profiles of all the users A, B, C, D subscribing to the videophone dating service.

The web server 10 also includes means for creating separate groups G1, G2 of people as a function of their profile as described above with reference to the step E10 of FIG. 1.

All this information is preferably grouped in a database 5 that includes the subscriber profiles, information concerning the organization of future sessions (session time and duration, list of people participating, etc.) and assessments A_{AB}, A_{BA} by users of interviews they have already had.

The system of the invention optionally includes an SMS or messaging server for confirming the holding of a connection session to subscribers to the dating service, for example two hours before the session begins.

According to the invention, the system automatically sets up successive interviews between people from different groups.

To this end, it includes means for selecting two people belonging to different groups.

In the preferred embodiment described here, this function is implemented by the web server 10.

The web server 10 is consequently adapted to implement the step E30 already described of selecting two people in different groups, for example in alphabetical order or using an assessment by a user of a preceding interview.

The system also includes means for setting up one or more audio and video data streams between two selected people.

To initiate a interview, the session server 10 sends a message M1 to a call distributor 20 adapted to determine a call launcher or MCU (multipoint central unit) for launching a call between those subscribers, for example by means of a round-robin type calculation.

In this way the call distributor 20 accesses the database 5 (message M2) to obtain the information necessary to set up a interview (addresses of terminals, interview time t1 and duration D1 in particular).

Once the bridge 30 has been selected, the call distributor 20 sends the bridge 30 a message M3 giving it the characteristics of the interview so that it can set up an audio and video data stream between the participants.

In the preferred embodiment described here, the call launcher 30 in fact sets up two streams f1, f2 between itself and each of the two participants A, B, respectively, thus occupying a break-in position in the data stream between the two people, enabling it to break off that stream (step E50) after the predetermined interview duration D1.

At the end of the predetermined duration D1, the call launcher 30 breaks off the stream between the two participants A and B and sends a message M4 to the session server to inform it of the end of the interview.

As described previously, in a preferred embodiment, the session server 10 can send a message M5 to the call distributor 20 to request it to set up a session between one of the participants A, B and the video portal 40 for storing an assessment on the completed interview.

That message M5 is preferably sent only in respect of subscribers using a videophone dedicated to the dating service.

On receipt of this message M5, the call distributor therefore sets up a call between the user's videophone and the videophone portal 40.

The assessment by the user of the previous interview is preferably sent to the video portal 40 by sending a message M6 consisting of a sequence of DTMF commands.

The video portal 40 sends the session server 10 a request to store this assessment in the data structure of the server.

The system preferably also includes an administration site enabling an administrator to draw up statistics on the use of the videophone dating service, for example by means of requests sent to the aforementioned units.

The system of the invention preferably also includes means for billing for the service.

1.-14. (canceled)

15. A method of connecting people in a telecommunications network, the method including a step of creating two or more groups of people as a function of their profiles and the method being characterized in that it sets up communications between people belonging to two groups for combinations of people belonging to the two groups, the setting up of said communication comprising:
a step of selecting two people belonging respectively to two groups;
a step of setting up one or more data streams between said people;
a step of breaking off said one or more data streams after a predetermined duration; and
a step of storing an assessment on said communication by at least a first person of the two people in a data structure accessible to the two people.

16. A method according to claim 15, further comprising, after said breaking off step:
creating a session set up between said first person and a portal of said network; and
sending said assessment from the first person to the portal during said session;
wherein said storage step is executed by said portal.

17. A method according to claim 16, wherein said assessment is sent to said portal in the form of a DTMF command.

18. A method according to claim 15, further comprising the step of using at least an assessment of a previous communication to set up said communication during said selecting step.

19. A system for connecting people in a telecommunications network, the system including means for creating two or more separate groups of people as a function of their profiles and the system being characterized in that it includes means for setting up communications between people belonging to two groups, for combinations of people belonging to the two groups, comprising:
means for selecting two people belonging respectively to two groups;
means for setting up one or more data streams between said people;
means for breaking off said one or more data streams after a predetermined duration; and
a data structure accessible by two people who have participated in a communication to store an assessment of said communication by at least a first person of the two people.

20. A system according to claim 19, further comprising:
means for setting up, after a communication between two people, a session between said first person and a portal of said network, said portal including:
means for obtaining said assessment from said first person; and
means for storing said assessment in the data structure.

21. A system according to claim 20, wherein said assessment obtaining means are adapted to obtain said assessment in the form of a DTMF command.

22. A system according to claim 19, wherein said selection means use at least one assessment of a preceding communication to set up a communication.

23. A call launcher that can be used in a telecommunications network, comprising:
means for establishing, on reception of a message (M3), one or more audio and video streams between two terminals of said network at a predetermined time; and
means for breaking off said stream after a predetermined duration.

24. A computer program stored on an information medium, comprising means for executing:
a step for establishing on reception of a message one or more audio and video streams between two terminals of said network at a predetermined time; and
a step of breaking off said one or more streams after a predetermined duration.

25. An information medium readable by a call launcher, comprising instructions of a computer program according to claim 24.

26. A server adapted to be used in a telecommunications network, comprising:
means for creating two or more separate groups of people as a function of their profile; and
means for initiating contact by videophone between all possible combinations of two people belonging to respective groups.

27. A computer program stored on an information medium, comprising instructions for executing:
a step of creating two or more separate groups of people as a function of their profile; and
a step of initiating contact by videophone between all possible combinations of two people belonging to respective groups.

28. An information medium readable by a server, comprising instructions of a computer program according to claim 27.
